(19) United States
(12) Patent Application Publication
(10) Pub. No.: US 2002/0176130 A1
(43) Pub. Date: Nov. 28, 2002

(54) Optical network with fault/normal pattern tables for identifying location of path failure

(76) Inventor: Yoshiharu Maeno, Tokyo (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/152,626

(22) Filed: May 23, 2002

(30) Foreign Application Priority Data
May 24, 2001 (JP) 2001-154900

(51) Int. Cl. H04B 10/08; H04B 10/20; H04J 14/00

(52) U.S. Cl. 359/110; 359/119

(57) ABSTRACT

In an optical node of an optical communication network, a number of paths are accommodated through optical node components between incoming and outgoing optical links of the node. A first table memory divides each of the established paths into a number of successive optical fiber sections and stores a matrix pattern of reference fault/normal indications of the paths and the optical fiber sections. A second table memory is provided into which a pattern of actual fault/normal indications of the established paths is stored when an alarm message is received from the downstream end of an established path. When this occurs, one of the optical fiber sections is identified as faulty if the corresponding pattern of the reference fault/normal indications coincides with the pattern of the actual fault/normal indications.

### BACKGROUND OF THE INVENTION

1. Field of the Invention

The present invention relates generally to optical communication networks where transparent optical nodes are interconnected by optical links and a plurality of paths are established over a number of optical links, and more particularly to a method and system for identifying the location of a failure in a transparent optical communication network when an abnormal condition is detected at the downstream end of a path.

2. Description of the Related Art

In a communications network such as SONET (synchronous optical network) as shown and described in Japanese Patent Publications 2000-183853 and 2000-312189, network nodes are interconnected by optical links and frames transmitted on each link (or SONET Section) are monitored at its downstream end by a signal quality analyzer, where their B1 parity byte of section overhead is examined to determine the bit error rate. Opto-electrical conversion is thus necessary to process signals as well as to determine bit error rate. Additionally, electro-optical conversion is required for transmitting frames to optical links. For dynamically establishing optical paths in the optical network, it is necessary to ensure that desired speed and format can be used without restrictions. This is particularly important for a transparent optical communication network where electro-optical and opto-electrical conversion processes are not provided on user information signals. However, the use of such signal quality analyzers at the end of each SONET Section, or optical link imposes severe limitations on transmission speed and signal format that can be used. In most cases, the signal quality analyzer is used in applications where the format is limited to SONET OC48 (=2.5 Gbit/s).

In optical communication networks as disclosed in Japanese Patent Publications 2000-209244 and 2000-209152, optical signals are monitored only at the downstream end of a path to detect path failures. Since the path is a logical channel established over a number of optical links, it is impossible to determine the location of the failure along the path, nor identify the faulty link.

### SUMMARY OF THE INVENTION

It is therefore an object of the present invention to provide a transparent optical communication network in which the location of a failure can be identified and paths can be dynamically established with no limitations on available transmission speed and signal format.

According to a first aspect of the present invention, there is provided an optical communication network comprising a plurality of optical nodes interconnected by optical links. Each of the nodes comprises a plurality of optical node components for accommodating a plurality of paths between incoming and outgoing optical links, a first table memory for dividing each of the paths into a plurality of successive sections and storing a matrix pattern of reference fault/normal indications of the paths and the sections, and a second table memory. A path controller is provided for storing a pattern of actual fault/normal indications of the paths in the second table memory in response to an alarm message, and identifying one of the sections as faulty if the corresponding pattern of the reference fault/normal indications coincides with the pattern of the actual fault/normal indications.

According to a second aspect, the present invention provides a fault locating method for an optical communication network which includes a plurality of optical nodes interconnected by optical links, wherein each of the nodes comprises a plurality of optical node components for accommodating a plurality of paths between incoming and outgoing optical links. The method comprises the steps of dividing each of the paths into a plurality of successive sections and storing a matrix pattern of reference fault/normal indications of the paths and the sections in a first table memory, storing a pattern of actual fault/normal indications of the paths in a second table memory in response to an alarm message, and identifying one of the sections as faulty if the corresponding pattern of the reference fault/normal indications coincides with the pattern of the actual fault/normal indications.

### BRIEF DESCRIPTION OF THE DRAWINGS

The present invention will be described in detail further with reference to the following drawings, in which:

FIG. 1 is a block diagram of a transparent optical communication network embodying the present invention;

FIG. 2 is a block diagram of the details of an optical switching node of the network for illustrating a number of optical fiber sections into which the transmission elements of the node are divided according to a first embodiment of the present invention;

FIG. 3 is a flowchart of the operation of the path controller of the node of FIG. 2 when a path setup message is received from an upstream node;

FIG. 4 is an illustration of a path management table of the node;

FIG. 5 is an illustration of a reference table of the node for creating an entry when a path is established in the network for storing fault/normal symbols according to the first embodiment of the present invention;

FIG. 6 is an illustration of a status table of a node for recording actual fault/normal status of paths established through the node according to the first embodiment of the present invention;

FIG. 7 is a flowchart of the operation of the path controller when a path failure is detected by a downstream node or a low quality indication is produced by the signal quality analyzer of the node;

FIG. 8 is a block diagram of the optical switching node of the network for illustrating a number of optical fiber sections into which the transmission elements of the node are divided according to a second embodiment of the present invention;

FIG. 9 is an illustration of the reference table for creating an entry when a path is established in the network for storing fault/normal symbols according to the second embodiment of the present invention;

FIG. 10A is an illustration of the status table of a node for recording actual fault/normal status of paths established through the node according to the second embodiment of the present invention; and

FIG. 10B is an illustration of a matrix pattern of fault/normal states stored in the status table when sub-section C2 fails.

### DETAILED DESCRIPTION

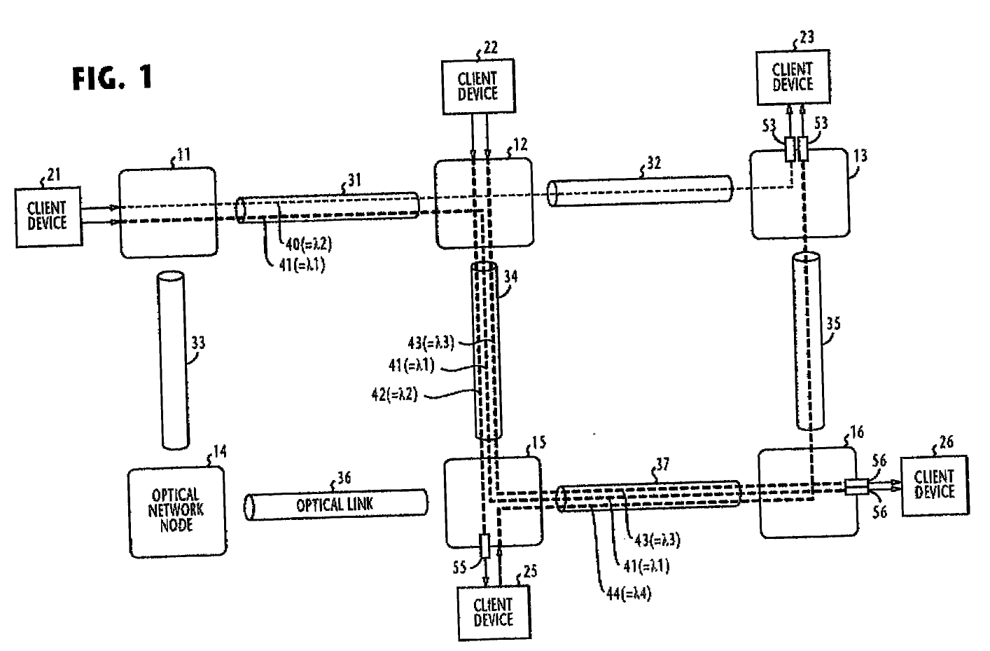

A transparent optical communication network, shown in FIG. 1, is comprised of a plurality of optical switching nodes 11 to 16, which are interconnected by optical links 41 to 47. Client devices 21, 22, 23, 25 and 26 are connected to nodes 11, 12, 13, 15, and 16, respectively. Wavelength is the resource of the network for carrying traffic messages. The wavelength is identified by a wavelength number which is assigned when an optical path is established in the network. No electro-optical and opto-electrical conversion processes are performed and hence the optical path is transparent between source and destination nodes. The path is assigned a path number which is unique to all nodes of the network, whereas the same wavelength may be assigned to more than one path.

Optical switching nodes 11 to 16 are interconnected by optical links 31 to 37 for establishing optical paths (hereinafter called “paths” for simplicity). As a typical example, paths 41 to 44 are established as follows:

Path 40 on wavelength λ2 from node 11 to node 13 via node 12 for communication from client device 21 to client device 23;

Path 41 on wavelength λ1 from node 11 to 16 via nodes 12 and 15 for communication from client device 21 to client device 26;

Path 42 on wavelength λ2 from node 12 to node 15 for communication from client device 22 to client device 25;

Path 43 on wavelength λ3 from node 12 to node 16 via node 15 for communication from client device 22 to client device 26; and

Path 44 on wavelength λ4 from node 15 to node 13 via node 16 for communication from client device 25 to client device 23.

At the receive end of each one-way path, a signal quality analyzer is provided in as shown at 53, 55 and 56 in destination nodes 13, 15 and 16.

Although not shown in FIG. 1, logical control channels are established in the network for carrying control messages such as path setup messages and alarm messages. When the signal quality analyzer of a downstream node detects an abnormal condition of a path, the node formulates and transmits an alarm message over the control channel upstream to the source node.

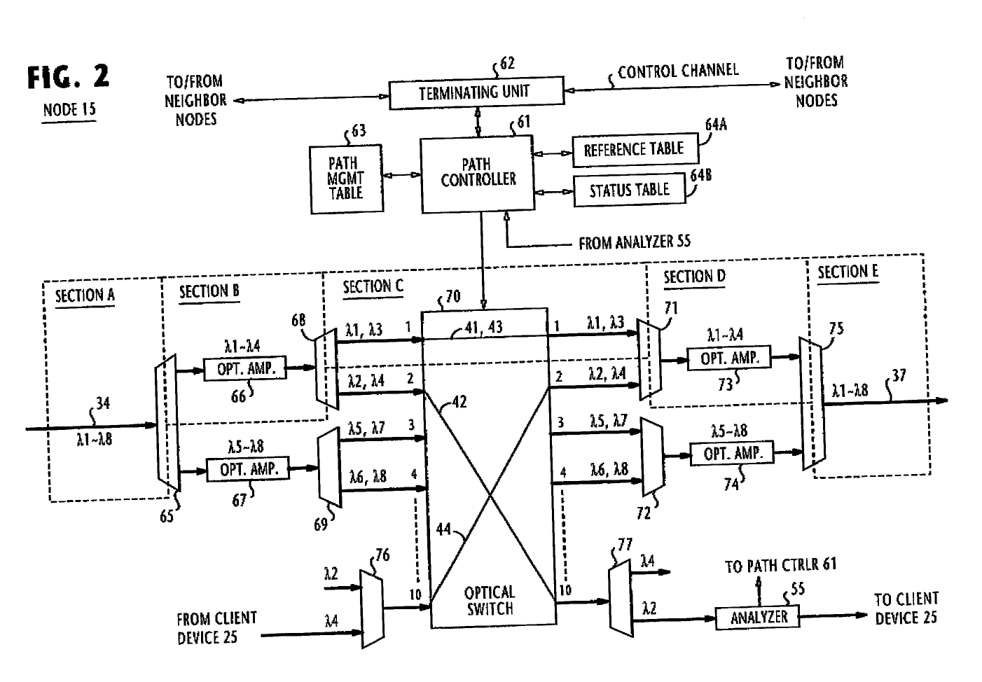

As a representative node, details of the optical node 15 are shown in FIG. 2. Node 15 is comprised of a path controller 61 which associates itself with a terminating unit 62 for exchanging control messages with neighbor nodes. Controller 61 is further associated with a number of table memories including a path management table 63, a reference table 64A, a status table.

Traffic channels of different wavelengths are multiplexed onto an optical link for transmission and demultiplexed into component channels upon reception. In one example, wavelength channels λ1 to λ8 are multiplexed onto the optical link 34 from the neighbor upstream node 12. This optical link is terminated on a wavelength demultiplexer 65 for separating the eight component channels into a first group of wavelength channels λ1 to λ4 and a second group of wavelength channels λ5 to λ8. After amplification by optical amplifiers 66 and 67, the first-group optical signals are further divided by a wavelength demultiplexer 68 into a first pair of wavelength channels λ1 and λ3 and a second pair of wavelength channels λ2 and λ4, and the second-group optical signals are further divided by a wavelength demultiplexer 69 into a third pair of wavelength channels λ5 and λ7 and a fourth pair of wavelength channels λ6 and λ8.

The first to fourth pairs of optical channels are supplied to the corresponding input ports of an optical switch 70. Optical switch 70 establishes a transparent connection between one of its input ports and one of its output ports in response to a switching command signal from the path controller 61. The wavelength channel λ4 of client device 25 may be multiplexed with a wavelength channel λ2 by a multiplexer 78 onto the input port-10.

In Fig, 2, it is seen that the switch 70 has established a first connection between the input port-1 and the output port-1 to accommodate the paths 41 and 43, a second connection between the input port-2 and the output port-10 to accommodate the path 42 and a third connection between the input port-2 and the output port-10 to accommodate the path 42 and a fourth connection between the input port-10 and the output port-2 to accommodate the path 44.

The wavelength channels that appear at the output ports-1 and 2 of the switch 70 are multiplexed by a wavelength multiplexer 71 onto an optical amplifier 73 to amplify wavelengths λ1 to λ4 for application to one input of a wavelength multiplexer 75. A wavelength multiplexer 72 combines channels λ5, λ7 with channels λ6, λ8 which may appear at the output port-3 and the output port-4. After amplification by an optical amplifier 74, channels λ5 to λ8 are applied to a second input of the multiplexer 75. Channels λ1 to λ8 are multiplexed onto the optical link 37 for transmission to the neighbor downstream node 16. The output port-10 may be coupled to a wavelength demultiplexer 77 for separating its input channels into component wavelengths λ2 and λ4. Channel λ2 is transmitted to the client device 25 via the analyzer 55.

All the transmission elements of the switching node are divided into a plurality of “optical fiber sections” for identifying the location of a fault when a path fails. The transmission elements are divided into five sections A, B, C, D and E.

Section A covers the incoming link (upstream) side of the wavelength demultiplexer 65, and the section B extends between the wavelength demultiplexers 65 and 68, the section C extending between the wavelength demultiplexer 68 and the wavelength multiplexer 71, the section D extending between the wavelength multiplexers 71 and 75, and the section E covering the outgoing link (downstream) side of the wavelength multiplexer 75.

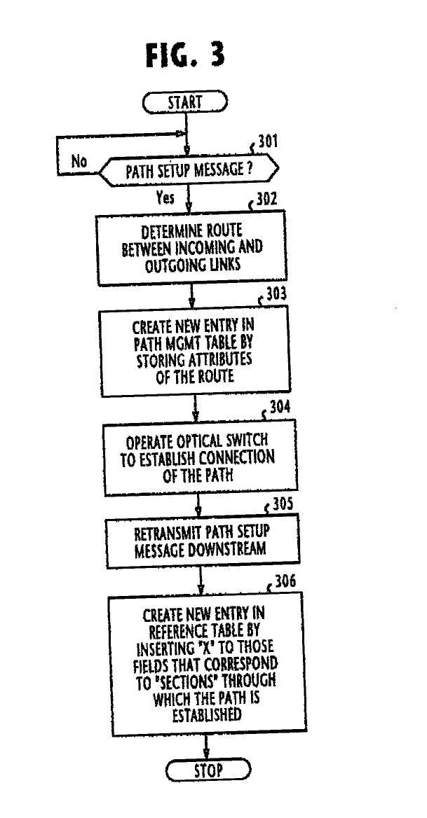

During a path setup phase, the path controller 61 operates according to the flowchart of FIG. 3 to create an entry in the path management table 63 and reference table 64A.

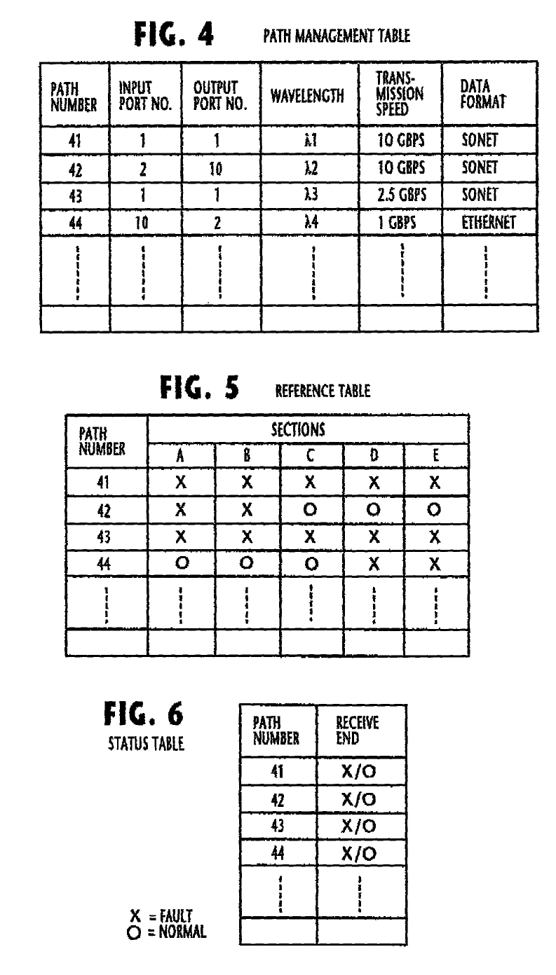

When a path setup message is received from the upstream side of the node (step 301), the path controller 61 assigns a path number and a wavelength number and determines a route between the incoming link 34 and the outgoing link 37 according to the destination address and the attributes of the path (step 302) and creates an entry in the path management table 63 (step 303). Each entry of the path management table 63 specifies the path number, the input and output ports of the optical switch 70, the wavelength number, the transmission speed, the transmission data format as shown in FIG. 4.

Then, the path controller 61 operates the optical switch 70 to establish a connection of the path between the input and output ports specified in the path management table (step 304), and reformulates the path setup message with the information specified in the path management table 63 and transmits the message downstream (step 305).

At step 306, the path controller 61 identifies the sections of the node through which the path is established and creates an entry in the reference table 64A. As shown in FIG. 5, each entry of the reference table 64A is divided into a plurality of fields corresponding to the sections A to E. For each path, the path controller 61 marks one or more fields of its entry with a symbol “X” which correspond to the sections through which the path is established and marks one or more fields of that entry with a normal symbol “O” that correspond to the sections through which the path is not established.

If the paths 41 and 43 are established through sections A to E as shown in FIG. 2, all fields of the entries of paths 41 and 43 are marked wit symbols “X”. If the path 42 is established through sections A and B, the A- and B-section fields of its entry are marked with fault symbol “X” and the other section fields are marked with normal symbol “O”. In a similar manner, the D- and E-section fields of the entry for path 44 are marked with symbol “X” and the other section fields are marked with normal symbol “O”.

It is seen therefore that the reference table 64A divides each of the paths accommodated by the node components into the successive sections A through E and stores a matrix pattern of reference fault/normal indications of the paths and the sections.

The fault/normal states of paths 41 to 44 of the node 15 are recorded in the status table 64B as shown in FIG. 6. If the paths 41 and 43 fail simultaneously, the signal quality at the receive end of each path degrades, and hence the signal quality analyzers 56 of node 16 simultaneously produce alarm signals. When this occurs, the node 16 formulates and transmits an alarm message upstream and the node 15 responds to this message by marking the entries of the status table 64A corresponding to the path numbers indicated in the alarm message. In such instances, the entries corresponding to the paths 41 and 43 are marked “X”.

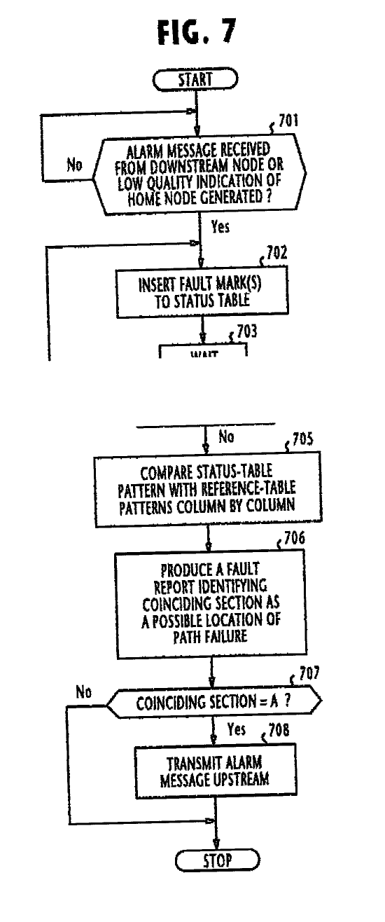

The operation of the path controller 61 of node 15 when a path failure occurs in the network proceeds according to the flowchart of FIG. 7.

In response to receipt of an alarm message from a downstream node or in response to the generation of a low quality indication by the analyzer of its own node (step 701), the path controller 61 inserts a symbol mark “X” in the entries of status table 64B that correspond to the path numbers informed by the alarm message (step 702). Path controller 61 then waits a predetermined amount of time (step 703) to check for the receipt of an alarm message from another downstream node (step 704). If more than one alarm message has been received in succession, the decision at step 704 is affirmative and the path controller repeats step 702 to insert additional fault marks in the status table 64B.

In order to identify the location of the failure, the path controller 61 compares the fault/normal pattern of the status table 64B with the patterns of the reference table 64A column by column in search of coincidence (step 705).

For example, if the section C of node 15 fails, both analyzers 56 of the node 16 simultaneously produces low-quality indications and the node 16 formulates and transmits an alarm message upstream to communicate that paths 41 and 43 are faulty. At the node 15, the path controller 61 responds to the alarm message by marking those entries of status table 64B with symbol “X” that correspond to the paths 41 and 43, producing a pattern “XOXO”. Path controller 61 of node 15 thus detects the corresponding pattern in the field of section C of reference table 64A and produces a fault report indicating that the coinciding section C is a possible location of the cause of the path failures (step 706).

If the section D of node 15 fails, one of the analyzers 53 of node 13 produces a low-quality indication and the node 13 transmits an alarm message upstream, indicating that path 44 is faulty. In addition, both analyzers 56 of the node 16 simultaneously produce low-quality indications and the node 16 transmits an alarm message upstream to indicate that paths 41 and 43 are faulty. In response, the path 61 controller of node 15 marks the status table 64B, producing a pattern “XOXX”. Path controller 61 thus detects the coinciding pattern in the section-D field of reference table 64A at step 706.

If a failure occurs in the node 12 causing paths 41, 42 and 43 to fail simultaneously, the node 16 will respond and transmit an alarm message upstream, indicating that the paths 41 and 43 are faulty. At the same time, the analyzer 55 of node 15 generates a low quality indication. In such instances, the path controller 61 of node 15 marks the entries of paths 41, 42 and 43 of status table 64B by symbols “X”, producing a pattern “XXXO”, and detects the coinciding pattern with the section-A and -B fields of the reference table (step 705) and produces a fault report identifying the section A or B as a possible fault location (step 706).

At step 707, the path controller 61 makes a decision as to whether the section A is the one identified as coinciding with the status table 64B. If this is the case, the path controller 61 proceeds to step 708 to formulate an alarm message and transmits the message upstream for communicating the path numbers of all faulty paths to the neighbor node. If the coinciding section is other than the section A, the routine is terminated.

If no paths are established in one of the optical amplifiers 66 and 67 and the paths established over the other amplifier are detected as faulty, the section A cannot be uniquely identified as a fault location. For example, if no paths are established through the optical amplifier 67, as illustrated in FIG. 2, and the wavelengths λ1 to λ4 are detected as faulty, the section A or B is the possible location of fault. In such instances, it is preferable that the path controller make a decision, at step 707, as to whether the section A or B was identified as faulty at step 706, and if this is the case, the path controller transmits an alarm message upstream at step 708.

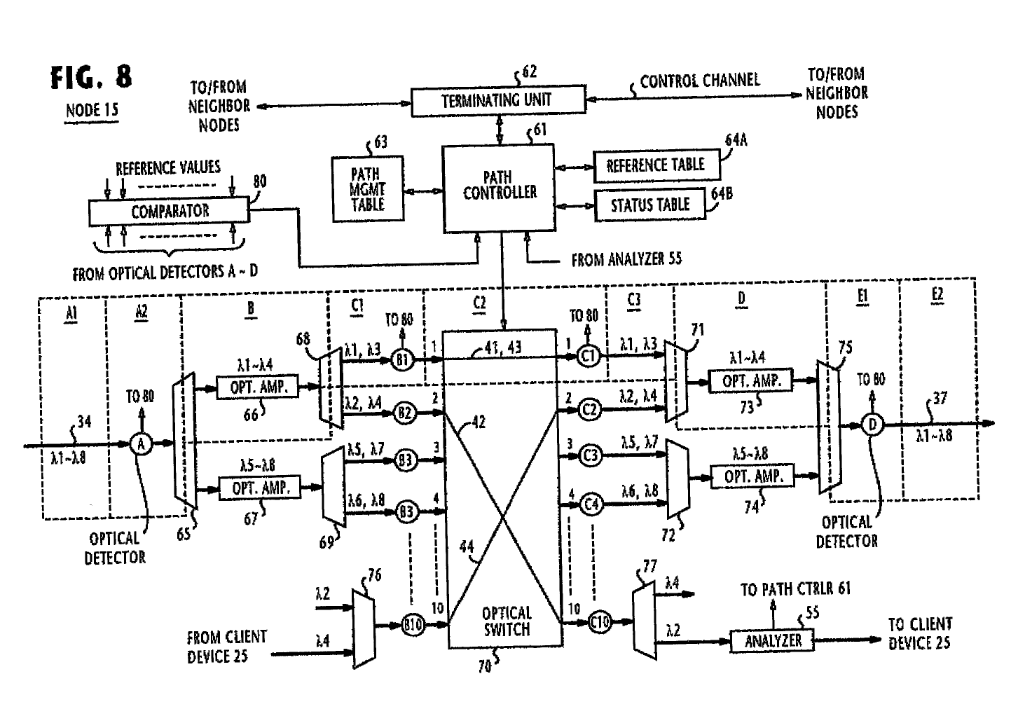

In order to pin down the fault location more exactly, the present invention is modified as shown in FIG. 8 by segmenting the transmission elements of the node into a greater number of sections by using fault monitors such as optical detectors for detecting the strength of optical signals or SNR detectors for detecting the signal-to-noise ratio of optical signals to produce a fault indication when the monitored strength or SNR reduces below a predetermined value.

As illustrated in FIG. 8, an optical detector A is connected in the incoming link 34, dividing the optical fiber section A into subsections A1 and A2. Optical detectors B1 to B10 are provided at the input ports of optical switch 70 and optical detectors C1 to C10 are provided at the output ports, dividing the section C into sub-sections C1, C2 and C3. An optical detector D is connected in the outgoing link 37 to divide the section E into sub-sections E1 and E2.

Each of the optical detectors monitors the associated optical fiber section and generates an electrical output signal indicating the strength of the optical signal of the monitored fiber section. The output signal of each optical detector is applied to a comparator 80, where the strength signal is compared with a reference value that is proportional to the number of wavelength channels transmitted on the monitored section. The result of the comparison by the comparator 80 for each optical detector is supplied to the path controller 61 as a fault/normal indication of the section or sub-section monitored by the optical detector.

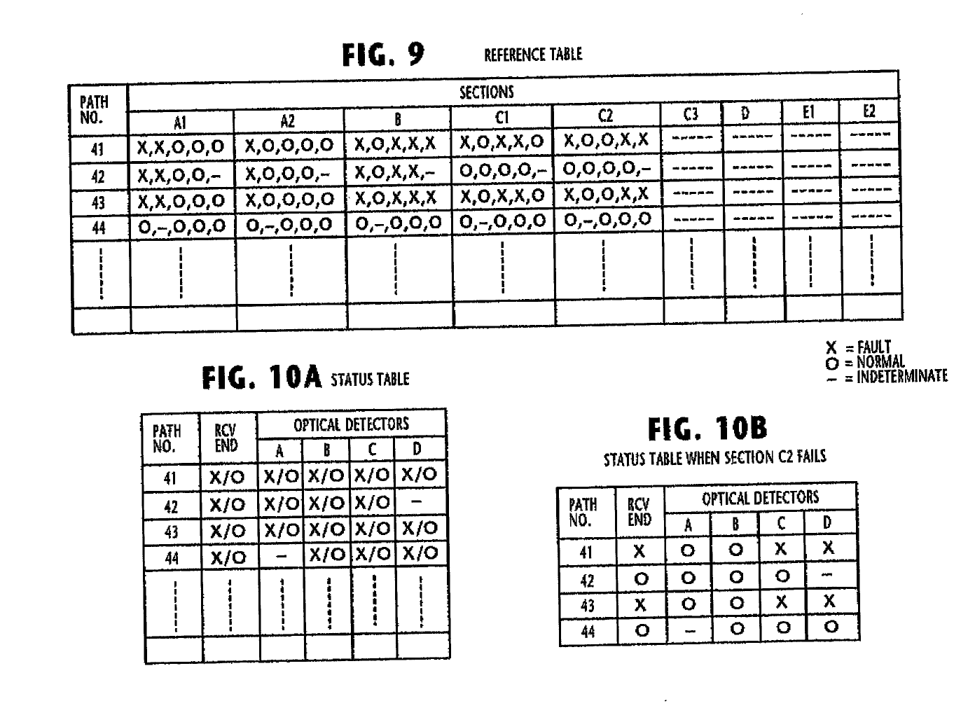

As shown in FIG. 9, each path entry of the reference table 64A of FIG. 8 is divided into a plurality of fields corresponding to the sections and subsections. Each of the fields of an entry contains a reference pattern of five fault/normal states indicated respectively by the receive end of the path and the optical detectors A through D when the path of the entry fails.

As shown in FIG. 10A, each path entry of the status table 64B of FIG. 8 is divided into a plurality of five fields respectively corresponding to the receive end of the path and the optical detectors A through D. Path controller 61 writes symbol “X” or “O” into the fields of an entry of the status table, depending on the fault/normal status indicated by the receive end of the path and the optical detectors A through D when the path of the entry fails.

If a failure occurs in the sub-section C2, the fault status of this subsection is detected by the comparator 80 from the outputs of optical detectors C1 and D and detected by the receive end (i.e., analyzers 56) of node 16. In response, the path controller 61 marks those fields of status table with symbols “X” that correspond to paths 41 and 43 and optical detectors C1 and D as shown in FIG. 10B. This matrix pattern is compared by the path controller 61 with the matrix patterns of reference table column by column for coincidence. Therefore, when the paths 41 and 43 are detected as faulty at their receive ends by the node 16 and the path controller 61 of node 15 receives an alarm message therefrom, a matrix pattern of symbols such as shown in FIG. 10B is produced by the status table of node 15. Therefore, the path controller detects its corresponding pattern in the sub-section C2 field of the reference table and produces a fault report identifying the sub-section C2 as a possible location of the failures of paths 41 and 43.

What is claimed is:

1. An optical communication network comprising a plurality of optical nodes interconnected by optical links,
each of said nodes comprising:
a plurality of optical node components for accommodating a plurality of paths between incoming and outgoing optical links;
a first table memory for dividing each of said paths into a plurality of successive sections and storing a matrix pattern of reference fault/normal indications of said paths and said sections;
a second table memory; and
a path controller for storing a pattern of actual fault/normal indications of said paths in said second table memory in response to an alarm message, and identifying one of the sections as faulty if the corresponding pattern of said reference fault/normal indications coincides with the pattern of said actual fault/normal indications.

2. The optical communication network of claim 1, wherein said path controller establishes said paths through said optical node components in response to respective path setup messages and creates said matrix pattern of reference fault/normal indications in said first table memory.

3. The optical communication network of claim 1, wherein said path controller compares the pattern of said actual fault/normal indications with the matrix pattern of said reference fault/normal indications for identifying one of said sections as faulty when said alarm message is received from more than one node of the network during a predetermined time interval.

4. The optical communication network of claim 1, wherein said path controller transmits an alarm message to an upstream neighbor node when the section identified as faulty forms part of said incoming optical link.

5. The optical communication network of claim 1, further comprising a plurality of fault monitors provided in said optical node components for dividing each of said paths into said sections and detecting when each of the sections becomes faulty,
said first table memory storing a plurality of matrix patterns of reference fault/normal indications of said paths so that each of the matrix patterns corresponds to each of said sections,
said path controller storing a matrix pattern of actual fault/normal indications in said second table memory in response to said alarm message and in response to outputs of said fault monitors, and identifying one of said sections as faulty if the corresponding matrix pattern of said reference fault/normal indications coincides with the matrix pattern of said actual fault/normal indications.

6. The optical communication network of claim 5, wherein said path controller creates said plurality of matrix patterns of reference fault/normal indications in said first table memory in response to said respective path setup messages.

7. The optical communication network of claim 1, wherein each of said optical nodes when functioning as a node for terminating one of said paths includes a fault detector at a downstream end of the path for detecting a path failure, and wherein the path controller transmits said alarm message toward an upstream end of the path when said fault detector detects said path failure for communicating an identification of the failed path.

8. The optical communication network of claim 1, wherein said optical node components comprise:
a plurality of wavelength demultiplexers connected in successive stages for successively demultiplexing multiplexed wavelength channels into individual wavelength channels;
a plurality of wavelength multiplexers connected in successive stages for successively multiplexing said individual wavelength channels into said multiplexed wavelength channels; and
an optical switch having a plurality of input ports connected to said wavelength demultiplexers and a plurality of output ports connected to said wavelength multiplexers,
said path controller controlling said optical switch to establish an optical transparent connection between one of said input ports and one of said output ports in response to each of said path setup messages.

9. The optical communication network of claim 8, further comprising a plurality of optical amplifiers connected between the successive stages of said wavelength demultiplexers and between the successive stages of said wavelength multiplexers.

10. The optical communication network of claim 8, further comprising a wavelength multiplexer having an output terminal connected to one of said input ports of the optical switch and a wavelength demultiplexer having an input terminal connected to one of said output ports of the optical switch.

11. A fault locating method for an optical communication network which includes a plurality of optical nodes interconnected by optical links, wherein each of said nodes comprises a plurality of optical node components for accommodating a plurality of paths between incoming and outgoing optical links, the method comprising the steps of:
a) dividing each of said paths into a plurality of successive sections and storing a matrix pattern of reference fault/normal indications of said paths and said sections in a first table memory;
b) storing a pattern of actual fault/normal indications of said paths in a second table memory in response to an alarm message; and
c) identifying one of the sections as faulty if the corresponding pattern of said reference fault/normal indications coincides with the pattern of said actual fault/normal indications.

12. The method of claim 11, wherein step (a) comprises the steps of establishing said paths through said optical node components in response to respective path setup messages and creating said matrix pattern of reference fault/normal indications in said first table memory.

13. The method of claim 11, wherein step (c) comprises the steps of comparing the pattern of said actual fault/normal indications with the matrix pattern of said reference fault/normal indications for identifying one of said sections as faulty when said alarm message is received from more than one node of the network during a predetermined time interval.

14. The method of claim 11, futher comprising the step of transmitting an alarm message to an upstream neighbor node when the section identified as faulty forms part of said incoming optical link.

15. The method of claim 11, wherein each of said node further comprises a plurality of fault monitors provided in said optical node components for dividing each of said paths into said sections and detecting when each of the sections becomes faulty,
wherein step (a) further comprises the step of storing a plurality of matrix patterns of reference fault/normal indications of said paths in said first table memory when a path is established so that each of the matrix patterns corresponds to each of said sections,
wherein step (b) comprises storing a matrix pattern of actual fault/normal indications in said second table memory in response to said alarm message, and
wherein step (c) comprises identifying one of said sections as faulty if the corresponding matrix pattern of said reference fault/normal indications coincides with the matrix pattern of said actual fault/normal indications.

16. The method of claim 15, wherein step (a) further comprises the step of creating said plurality of matrix patterns of reference fault/normal indications in said first table memory in response to said respective path setup messages.

17. The method of claim 11, further comprising the steps of detecting a path failure at a downstream end of each of said paths and transmitting said alarm message toward an upstream end of the path for communicating an identification of the failed path.
